(19) United States
(12) Patent Application Publication
(10) Pub. No.: US 2025/0314395 A1
(43) Pub. Date: Oct. 9, 2025

(54) HOT WATER APPARATUS

(71) Applicant: NORITZ CORPORATION, HYOGO (JP)

(72) Inventors: Kentaro MASUMOTO, Hyogo (JP); Hiroaki NISHIDA, Hyogo (JP)

(73) Assignee: NORITZ CORPORATION, HYOGO (JP)

(21) Appl. No.: 19/079,440

(22) Filed: Mar. 13, 2025

(30) Foreign Application Priority Data
Apr. 9, 2024 (JP) 2024-062635

(51) Int. Cl. F24H 15/174; F24H 1/10; F24H 15/184; F24H 15/219; F24H 15/238; G05D 23/20

(52) U.S. Cl. CPC F24H 15/174; F24H 15/184; F24H 15/219; F24H 15/238; G05D 23/2039; F24H 1/107

(57) ABSTRACT

A valve device A of a hot water apparatus WH is capable of sequentially executing flow rate control in a temperature adjustment range mode and a flow rate adjustment range mode, as control modes, in a process where a rotation angle of a motor drive shaft 8 for a valve operation changes between a predetermined first angle α1 and a second angle α2. The temperature adjustment range mode is capable of changing a mixing flow rate ratio of heated hot water from a heat exchanger 11 and bypass hot water to adjust the hot water outlet temperature to the exterior. The flow rate adjustment range mode is capable of adjusting a total flow rate of hot water flowing through the valve device so that the flow rate of the heated hot water is changed while maintaining the flow rate of the bypass hot water at or below a predetermined minimum flow rate. In response to a first condition being satisfied in which the outlet side temperature Tout of the heat exchanger 11 is higher than a predetermined reference temperature Ta, change from the temperature adjustment range mode and from a boundary between the temperature adjustment range mode and the flow rate adjustment range mode to the flow rate adjustment range mode is prohibited.

### CROSS-REFERENCE TO RELATED APPLICATION

This application claims the priority benefits of Japanese application no. 2024-062635, filed on Apr. 9, 2024. The entirety of the above-mentioned patent application is hereby incorporated by reference herein and made a part of this specification.

### TECHNICAL FIELD

The disclosure relates to a hot water apparatus such as a hot water supply apparatus.

### RELATED ART

Patent Literature 1 (Japanese Patent No. 3674014) describes a hot water apparatus as a specific example.

The hot water apparatus described in this literature includes a heat exchanger capable of heating hot water using a burner, and a water inlet passage and a hot water outlet passage respectively connected to the inlet side and the outlet side of this heat exchanger are connected to each other via a bypass passage. This allows heated hot water heated by the heat exchanger to flow through the hot water outlet passage while mixing unheated bypass hot water flowing through the bypass passage with this heated hot water. The respective flow rates of the heated hot water and bypass hot water can be changed using, for example, two flow control valves (heat exchanger flow control valve, bypass flow control valve), thereby setting the temperature of the mixed hot water to or bringing the temperature close to a desired target hot water supply temperature (target hot water outlet temperature).

However, in the aforementioned related technology, there are issues to be resolved, as described below.

That is, there are valve devices described in Patent Literatures 2 and 3 (Japanese Patent No. 5004674 and Japanese Patent No. 3812614) as specific examples of valve devices, and in some cases, it may be desired to use such valve devices in place of the two flow control valves in the aforementioned hot water apparatus. More specifically, the valve devices described in Patent Literatures 2 and 3 are so-called three-way valves, and it is possible to use such a valve device as a mixing valve that enables heated hot water heated by the heat exchanger and unheated bypass hot water to flow into the first and second ports of this valve device, and enables the mixed hot water to flow out from the third port. Furthermore, the control modes for the valve device include a temperature adjustment range mode and a flow rate adjustment range mode. The temperature adjustment range mode is a control mode capable of changing the mixing flow rate ratio of heated hot water and bypass hot water to adjust the hot water outlet temperature to the exterior. The flow rate adjustment range mode is a control mode capable of changing the flow rate of heated hot water while maintaining the flow rate of bypass hot water at a predetermined minimum flow rate to adjust the hot water outlet flow rate to the exterior. With such a configuration, the total number of valve devices (flow control valves) used in the hot water apparatus can be reduced, making it possible to achieve simplification of the overall configuration of the hot water apparatus and reduction of manufacturing cost.

However, the aforementioned valve device cannot simultaneously execute temperature adjustment and overall flow rate adjustment of hot water. Therefore, for example, when a post-boiling phenomenon (a phenomenon where the hot water inside the heat exchanger is heated to a high temperature by residual heat after the operation of the hot water apparatus is turned off) occurs in the heat exchanger, and high-temperature hot water from post-boiling flows out from the heat exchanger to the hot water outlet passage, or when there is such a risk, if the valve device is set to the flow rate adjustment range mode, it is difficult to appropriately and quickly lower the temperature of the aforementioned high-temperature hot water. This poses a risk of outputting high-temperature hot water at the hot water supply destination. It is required to appropriately prevent such a risk.

The disclosure, conceived under the aforementioned circumstances, aims to provide a hot water apparatus that is capable of appropriately preventing or suppressing output of high-temperature hot water while using a valve device capable of flow rate control in a predetermined temperature adjustment range mode and a flow rate adjustment range mode, as a hot water flow rate control means.

### SUMMARY

The disclosure employs the following technical means.

A hot water apparatus provided by the disclosure includes: a water inlet passage and a hot water outlet passage respectively connected to an inlet side and an outlet side of a heat exchanger for hot water heating; a bypass passage bypassing the heat exchanger to connect the water inlet passage and the hot water outlet passage to each other, and mixing hot water from the water inlet passage, as bypass hot water, with heated hot water flowing through the hot water outlet passage; and a valve device capable of changing a flow rate of the heated hot water flowing through the hot water outlet passage and a flow rate of the bypass hot water flowing through the bypass passage. The hot water apparatus is capable of sequentially executing flow rate control in a temperature adjustment range mode and a flow rate adjustment range mode, as control modes of the valve device, in a process where a rotation angle of a motor drive shaft for a valve operation changes between a predetermined first angle and a second angle. The temperature adjustment range mode is capable of changing a mixing flow rate ratio of the heated hot water and the bypass hot water to adjust a hot water outlet temperature to exterior, and the flow rate adjustment range mode is capable of adjusting a total flow rate of hot water flowing through the valve device so that the flow rate of the heated hot water is changed while maintaining the flow rate of the bypass hot water at or below a predetermined minimum flow rate. A first condition is defined as that an outlet side temperature of the heat exchanger is higher than a predetermined reference temperature, and the valve device is configured so that, in response to the first condition being satisfied, a control mode change restriction is implemented to prohibit change from the temperature adjustment range mode and from a boundary between the temperature adjustment range mode and the flow rate adjustment range mode to the flow rate adjustment range mode.

This configuration provides the following effects.

That is, in a case where the first condition is satisfied in which the outlet side temperature of the heat exchanger is higher than the predetermined reference temperature, when high-temperature hot water is actually flowing out or may flow out from the heat exchanger, the control mode of the valve device is not changed to the flow rate adjustment range mode. Therefore, the difficulty in lowering the temperature of the hot water due to the valve device being in the flow rate adjustment range mode is avoided, despite high-temperature hot water being flowing out from the heat exchanger. In the temperature adjustment range mode of the valve device, it is possible to reliably lower the temperature of high-temperature hot water and appropriately prevent undue output of high-temperature hot water to the exterior.

In the disclosure, the predetermined reference temperature may be a target hot water outlet temperature, an outlet side target temperature of the heat exchanger, or a temperature determined based on the target hot water outlet temperature and the outlet side target temperature. This configuration may prevent or suppress the output of hot water that is considerably

higher in temperature than the target hot water outlet temperature or the outlet side target temperature of the heat exchanger from the hot water apparatus, with these temperatures as a reference.

In the disclosure, a second condition may be defined as that a cumulative flow rate of the heated hot water in the hot water outlet passage from a most recent start of hot water flow to a present time point has not reached a predetermined reference cumulative flow rate. In response to the second condition being satisfied instead of or in addition to the first condition, the control mode change restriction is implemented, and the control mode change restriction is configured to be released in response to both the first condition and the second condition being not satisfied. This configuration provides the following effects.

That is, in a situation where the hot water apparatus is switched from operation on to operation off, and a post-boiling phenomenon occurs in which the hot water in the heat exchanger is heated to a high temperature by residual heat, when the hot water apparatus is restarted and the hot water in the heat exchanger flows out to the hot water outlet passage, there is a risk that high-temperature hot water may flow out until the entire volume of hot water in the heat exchanger has finished flowing out (for example, when high-temperature hot water remains in the uppermost upstream portion of the heat exchanger). According to the aforementioned configuration, in such a case, at the stage where the entire volume of hot water in the heat exchanger has not finished flowing out, satisfying the second condition can prohibit the valve device from being set to the flow rate adjustment range mode. Therefore, it is possible to thoroughly prevent output of high-temperature hot water due to the post-boiling phenomenon. It also has an advantage that satisfying the second condition can accurately implement the control mode change restriction even if the establishment of the first condition is not detected due to reasons such as a failure of the temperature sensor.

Since the control mode change restriction is released when both the first and second conditions are not satisfied, inappropriate release of the control mode change restriction is avoided appropriately when there is a possibility of output of high-temperature hot water.

In the disclosure, a third condition may be defined as that an elapsed time from a most recent start of hot water flow to a present time point has not reached a predetermined reference time. In response to the third condition being satisfied instead of or in addition to the first condition, the control mode change restriction is implemented, and the control mode change restriction is configured to be released in response to both the first condition and the third condition being not satisfied.

This configuration provides the following effects.

That is, in a situation where the hot water in the heat exchanger has a post-boiling phenomenon when the hot water apparatus is off, at the stage where not much time has passed after the hot water apparatus is restarted, the third condition is considered to be satisfied, and the control mode change restriction can be implemented. Therefore, it is possible to prohibit the valve device from being set to the flow rate adjustment range mode at the stage where the entire volume of the high-temperature hot water in the heat exchanger has not finished flowing out, and to thoroughly prevent output of high-temperature hot water due to the post-boiling phenomenon.

Since the control mode change restriction is released when both the first and third conditions are not satisfied, inappropriate release of the control mode change restriction is avoided appropriately when there is a possibility of output of high-temperature hot water.

While the measurement target parameter of the previously mentioned second condition is the cumulative flow rate, the measurement target parameter of the third condition is time. Therefore, it is possible to achieve simplification of the control, etc.

In the disclosure, a fourth condition may be defined as that the outlet side temperature of the heat exchanger is in a predetermined unstable state. In response to the fourth condition being satisfied instead of or in addition to the first condition, the control mode change restriction is implemented, and the control mode change restriction is configured to be released in response to both the first condition and the fourth condition being not satisfied.

According to this configuration, when the outlet side temperature of the heat exchanger is not stable and there is a possibility that high-temperature hot water may flow out from the heat exchanger, the fourth condition is satisfied, making it more preferable to prevent output of high-temperature hot water.

Since the control mode change restriction is released when both the first and fourth conditions are not satisfied, inappropriate release of the control mode change restriction is avoided appropriately when there is a possibility of output of high-temperature hot water.

Other features and advantages of the disclosure will become more apparent from the description of the embodiments of the disclosure given below with reference to the attached figures.

### BRIEF DESCRIPTION OF DRAWINGS

FIG. 1 is a schematic explanatory diagram showing an example of the hot water apparatus according to the disclosure.

FIG. 2A is a partial side sectional view showing the valve device of the hot water apparatus in FIG. 1, FIG. 2B is a partial side sectional view of a part, different from FIG. 2A, of the valve device of the hot water apparatus in FIG. 1, and FIG. 2C is a bottom view of the valve device of the hot water apparatus in FIG. 1.

FIG. 3A is a partial side view of the valve body of the valve device shown in FIG. 2A to FIG. 2C, and FIG. 3B is a bottom view thereof.

FIG. 4A is a partial plan sectional view of the valve device shown in FIG. 2A to FIG. 2C, FIG. 4B is a partial plan sectional view of a part, different from FIG. 4A, of the valve device shown in FIG. 2A to FIG. 2C, and FIG. 4C is a bottom view of the valve device corresponding to FIG. 4A and FIG. 4B.

FIG. 5A is a sectional view showing a state where the valve body is rotated by a predetermined angle in the portion shown in FIG. 4A, FIG. 5B is a sectional view showing a state where the valve body is rotated by a predetermined angle in the portion shown in FIG. 4B, and FIG. 5C is a bottom view of the valve device corresponding to FIG. 5A and FIG. 5B.

FIG. 6A is a sectional view showing a state where the valve body is further rotated by a predetermined angle in the portion shown in FIG. 5A, FIG. 6B is a sectional view showing a state where the valve body is further rotated by a predetermined angle in the portion shown in FIG. 5B, and FIG. 6C is a bottom view of the valve device corresponding to FIG. 6A and FIG. 6B.

FIG. 7 is an explanatory diagram showing the control mode in the valve device of FIG. 2A to FIG. 2C.

FIG. 8 is a flowchart showing an example of the operation processing procedure executed in the hot water apparatus shown in FIG. 1.

FIG. 9 is a flowchart showing another example of the operation processing procedure executed in the hot water apparatus shown in FIG. 1.

FIG. 10 is a flowchart showing another example of the operation processing procedure executed in the hot water apparatus shown in FIG. 1.

FIG. 11 is a flowchart showing another example of the operation processing procedure executed in the hot water apparatus shown in FIG. 1.

### DESCRIPTION OF EMBODIMENTS

The following describes specifically exemplary embodiments of the disclosure with reference to the figures.

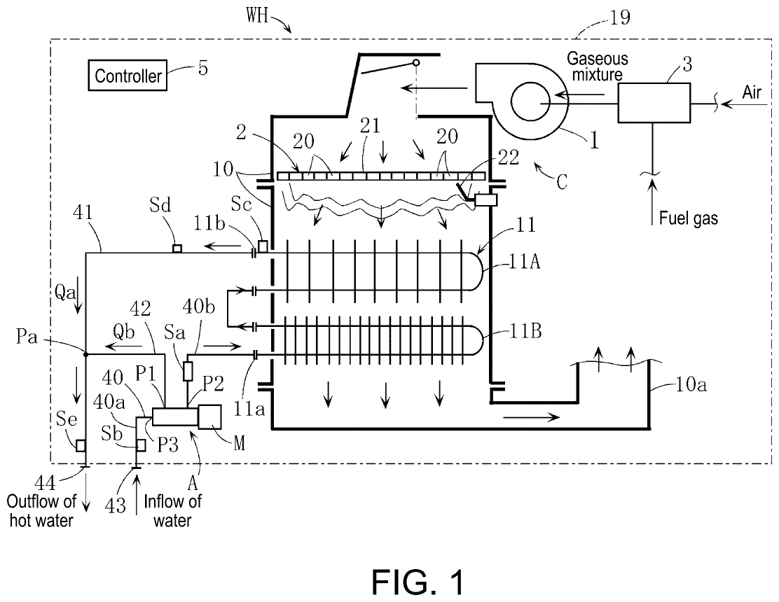

A hot water apparatus WH shown in FIG. 1 is configured as a hot water supply apparatus, and includes a premixing device 3, a combustion device C (premixing combustion device), a heat exchanger 11, hot water passages 40 to 42 to be described later, a valve device A, a controller 5, and an outer case 19 that houses these components internally and has a water inlet 43 and a hot water outlet 44.

The combustion device C is configured by combining a fan 1 and a burner part 2 with the premixing device 3. The premixing device 3 is a device that generates a gaseous mixture (combustible gaseous mixture) of air and fuel gas. The gaseous mixture is supplied to the burner part 2 by driving the fan 1. The burner part 2 has a configuration in which a porous plate 21 with multiple ventilation holes 20 is housed in a case 10, and an ignition plug 22 is attached. The gaseous mixture passes through the multiple ventilation holes 20, and combusts below the porous plate 21. Combustion gas generated by the burner part 2 acts on the heat exchanger 11, and the hot water passing through this heat exchanger 11 is heated. The heat exchanger 11 includes, for example, a primary heat exchange part 11A and a secondary heat exchange part 11B for sensible heat recovery and latent heat recovery, but is not limited thereto, and can also be configured with only the heat exchange part 11A for sensible heat recovery. After passing through the heat exchanger 11, the combustion gas passes through an exhaust duct part 10a of the case 10 and is discharged to the exterior as exhaust gas.

The water inlet 43 is, for example, a part where a water pipe is connected, and unheated hot water is supplied from the exterior. The hot water outlet 44 is a part for outputting hot water heated by the heat exchanger 11 to an external hot water supply destination.

The hot water apparatus WH has hot water passages including a water inlet passage 40, a hot water outlet passage 41, and a bypass passage 42.

Here, the water inlet passage 40 is a hot water passage from the water inlet 43 to an inlet 11a of the heat exchanger 11. The water inlet passage 40 is provided with the valve device A, a flow rate sensor Sa, and a temperature sensor Sb for detecting the water inlet temperature. The water inlet passage 40 is divided into two passages 40a and 40b, which are located on the upstream side and downstream side of the valve device A, respectively.

The hot water outlet passage 41 is a hot water passage from an outlet 11b of the heat exchanger 11 to the hot water outlet 44. The hot water outlet passage 41 is provided with a temperature sensor Sc for detecting an outlet side temperature Tout of the heat exchanger 11 (hereinafter abbreviated as heat exchanger outlet side temperature Tout where appropriate), a temperature sensor Sd for detecting abnormally high temperatures, and a temperature sensor Se for detecting the hot water temperature (hot water outlet temperature) on the downstream side of the connection point of the bypass passage 42.

The bypass passage 42 is a hot water passage that connects a part of the valve device A, which corresponds to an intermediate point of the water inlet passage 40, to an intermediate point Pa of the hot water outlet passage 41 to bypass the heat exchanger 11. Part of the hot water flowing through the water inlet passage 40 can be passed through the bypass passage 42 to flow into the intermediate point Pa of the hot water outlet passage 41. This makes it possible to generate mixed hot water with adjusted temperature by mixing the heated hot water in the hot water outlet passage 41 with the bypass hot water flowing through the bypass passage 42, and to output this mixed hot water from the hot water outlet 44.

The valve device A is capable of changing a flow rate Qa of the heated hot water flowing through the hot water outlet passage 41 and a flow rate Qb of the bypass hot water flowing through the bypass passage 42.

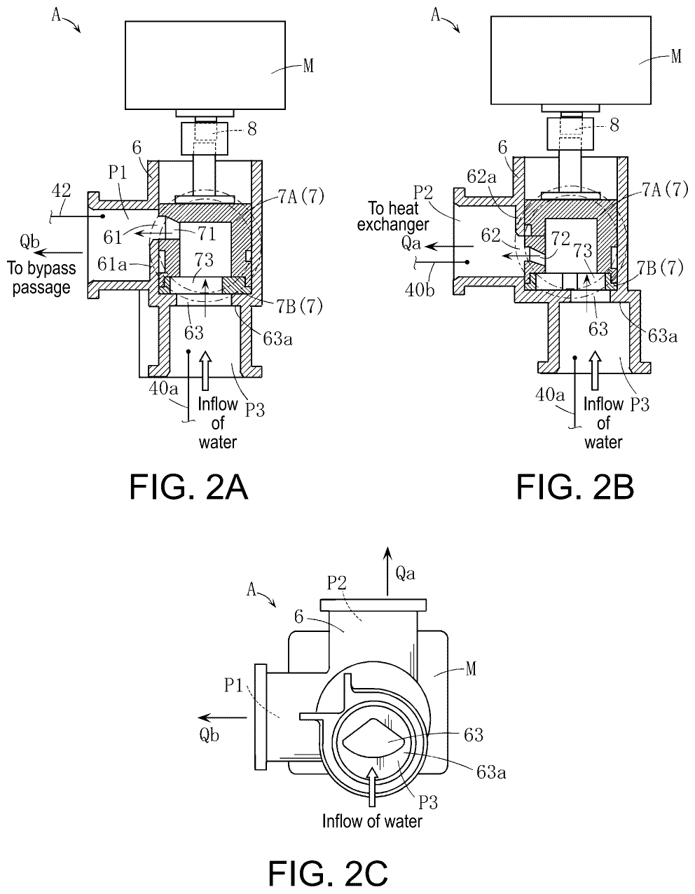

In FIG. 2A to FIG. 2C, the valve device A includes a case 6 having a first port P1 to a third port P3, a valve body 7 as a rotary valve body disposed in this case 6, and a drive shaft 8 (motor drive shaft 8) of a motor M for rotating this valve body 7.

The motor M is, for example, a stepping motor, and rotation angle control of the motor drive shaft 8 and the valve body 7 is possible.

In this embodiment, the valve device A is set to be used as a distribution valve that enables hot water flowing into the third port P3 to flow out to the first port P1 and the second port P2 (refer also to FIG. 1). The passage 40a on the upstream side of the water inlet passage 40 is connected to the third port P3, and unheated hot water supplied to the water inlet 43 flows in. The passage 40b on the downstream side of the water inlet passage 40 is connected to the second port P2, and the hot water flowing out from this second port P2 is sent to the heat exchanger 11. The bypass passage 42 is connected to the first port P1, and the hot water flowing out from this first port P1 flows through the bypass passage 42, and flows into the intermediate point Pa of the hot water outlet passage 41.

In FIG. 2A to FIG. 2C, partition wall parts 61a to 63a forming openings 61 to 63 for passing water are provided at positions close to the valve body 7 inside each of the first port P1 to the third port P3 of the case 6.

Further, the valve body 7 is a combination of a substantially cylindrical first valve body 7A that is open on the third port P3 side, and a second valve body 7B that is connected to the lower part of the first valve body 7A and rotates with the rotation of the first valve body 7A.

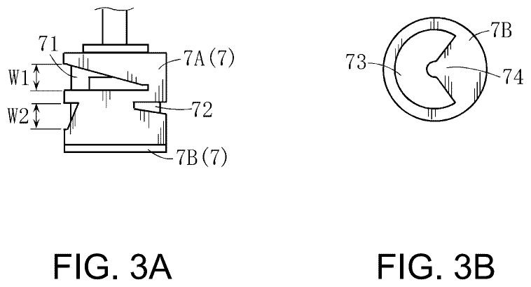

In the peripheral wall part of the first valve body 7A, a first opening 71 and a second opening 72 for passing water are provided to extend in the circumferential direction. The second valve body 7B is provided with a third opening 73 for communication with the third port P3, and a blocking part 74 that is fan-shaped when viewed from the bottom (refer also to FIG. 3A and FIG. 3B). The hot water flowing into the third port P3 can flow into the inside of the valve body 7 through the third opening 63, and then flow to the first port P1 and the second port P2 from the first opening 71 and the second opening 72 through the openings 61 and 62.

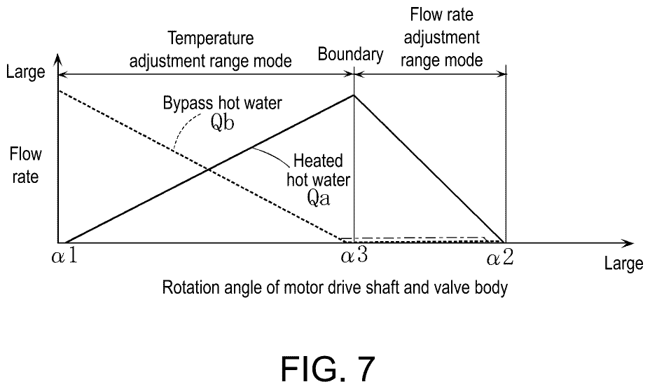

As shown in FIG. 7, the valve device A is capable of sequentially executing flow rate control in a temperature adjustment range mode and flow rate control in a flow rate adjustment range mode by changing the rotation angle of the motor drive shaft 8 and the valve body 7.

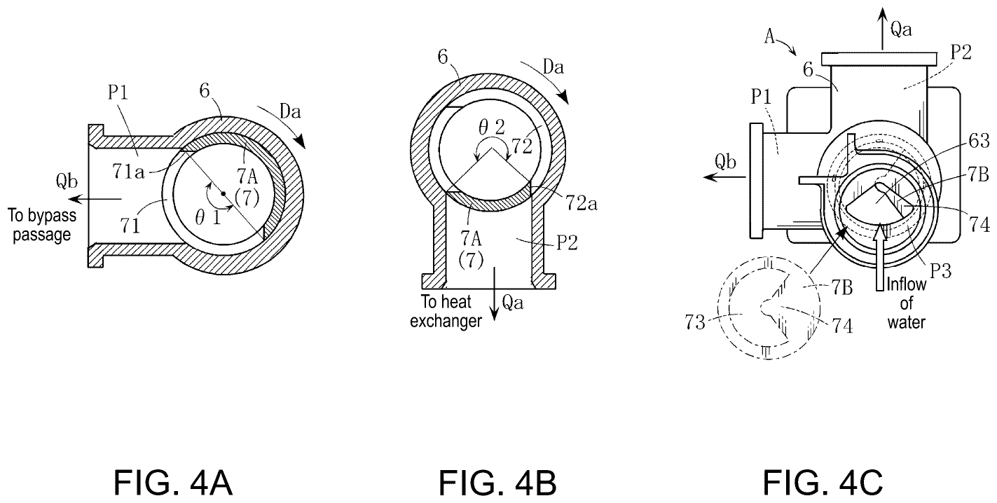

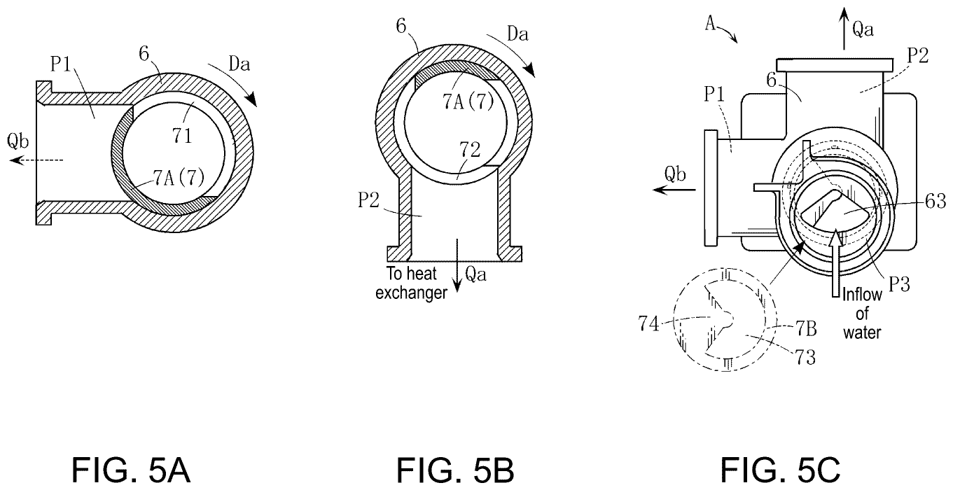

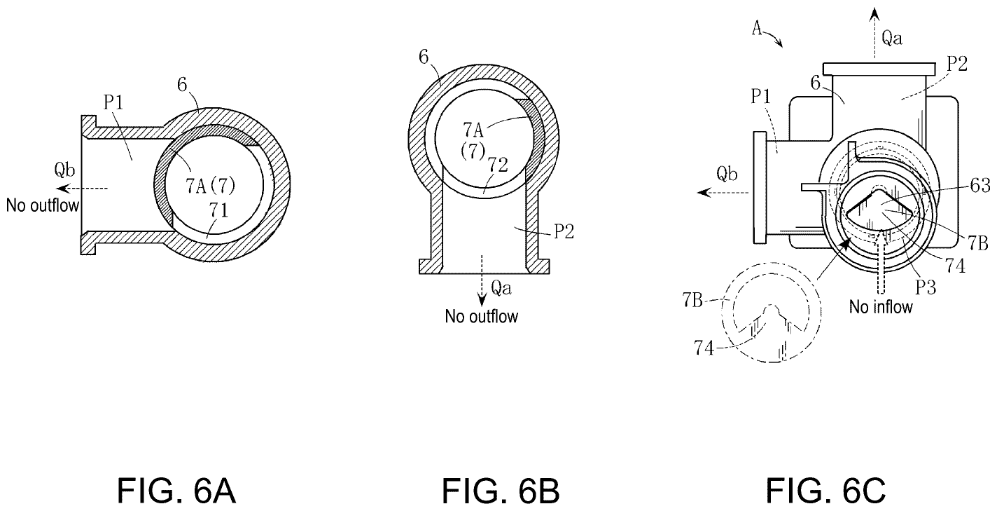

More specifically, the rotation angle of the motor drive shaft 8 and the valve body 7 can be changed from a predetermined first angle α1 to a second angle α2 beyond a predetermined boundary angle α3. The angular arrangement of the valve body 7 shown in FIG. 4A to FIG. 4C corresponds to the first angle α1. FIG. 5A to FIG. 5C and FIG. 6A to FIG. 6C correspond to the boundary angle α3 and the second angle α2, respectively.

When setting the first angle α1 as shown in FIG. 4A to FIG. 4C, the flow rate Qb of the bypass hot water is at the maximum, and the flow rate Qa of the heated hot water flowing through the hot water outlet passage 41 is zero.

That is, in this state, the third opening 63 is not blocked by the valve body 7 (second valve body 7B), allowing hot water to flow into the valve body 7. On the other hand, the communication area between the first opening 71 and the first port PI is large, allowing a large amount of hot water to flow from the first port P1 to the bypass passage 42. The second opening 72 and the second port P2 are not in communication, so no hot water flows from the second port P2 to the heat exchanger 11.

From the first angle α1 to the boundary angle α3 is the temperature adjustment range mode. In this temperature adjustment range mode, as the rotation angle of the drive shaft 8 and the valve body 7 increases, the flow rate Qb of the bypass hot water gradually decreases, while the flow rate Qa of the heated hot water flowing through the hot water outlet passage 41 gradually increases.

That is, while the valve body 7 rotates in the direction indicated by arrow Da from the state shown in FIG. 4A to FIG. 4C to the angle shown in FIG. 5A to FIG. 5C, the communication opening area between the first opening 71 and the first port P1 gradually decreases. Therefore, the flow rate Qb of the bypass hot water gradually decreases. The first opening 71, as shown in FIG. 4A, extends in the circumferential direction at an appropriate angle θ1, but the vertical width W1 thereof (FIG. 3A and FIG. 3B) becomes narrower as it moves away from one end 71a. In contrast, the communication area between the second opening 72 and the second port P2 gradually increases. The second opening 72, as shown in FIG. 4B, extends in the circumferential direction at an appropriate angle θ2, but the vertical width W2 thereof becomes wider as it moves away from one end 72a.

In the configuration shown in FIG. 5A, when the rotation angle of the valve body 7 (and the motor drive shaft 8) is at the boundary angle α3, the flow rate Qb of the bypass hot water becomes zero. Alternatively, it may be configured so that the flow rate becomes a small amount close to zero (the virtual line portion in FIG. 7).

From the boundary angle α3 to the second angle α2 is the flow rate adjustment range mode. In this flow rate adjustment range mode, as the rotation angle of the motor drive shaft 8 and the valve body 7 increases, while maintaining the flow rate Qb of the bypass hot water at or below a predetermined minimum flow rate (zero or a small amount close to zero), the total flow rate of hot water flowing through the valve device A is changed so that the flow rate Qa of the heated hot water flowing through the hot water outlet passage 41 gradually decreases. Eventually, the flow rates Qb and Qa of the bypass hot water and heated hot water both become zero.

That is, when the valve body 7 reaches the angle shown in FIG. 6A to FIG. 6C, the opening 63 for passing water is completely closed by the blocking part 74 of the second valve body 7B, and hot water no longer flows into the third port P3. As a result, the flow rates Qa and Qb become zero. In the process of the valve body 7 changing from FIG. 5A to FIG. 5C to FIG. 6A to FIG. 6C, although the second opening 72 and the second port P2 are in communication, the opening area of the opening 63 for passing water gradually decreases, and the flow rate of hot water into the third port P3 and the inside of the valve body 7 decreases, causing the flow rate Qa to decrease.

In the flow rate adjustment range mode, the total flow rate of hot water flowing through the valve device A may be changed while maintaining the ratio of the flow rate of the bypass hot water to the flow rate of the heated hot water at the boundary angle α3.

The controller 5 is configured using a microcomputer or the like, and executes operation control and data processing of each part of the hot water apparatus WH, as well as operation control of the valve device A. Nevertheless, the details will be described later.

It should be noted that a remote control (not shown) installed in the kitchen or bathroom is communicatively connected to the controller 5. By using this remote control, the user can appropriately set a target hot water outlet temperature Ta1 (target hot water supply temperature), etc.

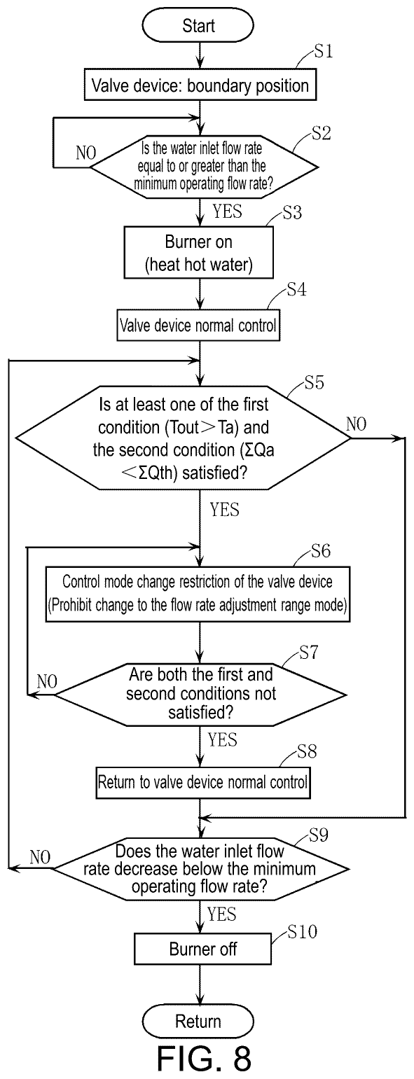

Next, an example of the operation processing procedure of the aforementioned hot water apparatus WH will be described with reference to the flowchart in FIG. 8. The function of the hot water apparatus WH will also be described.

First, during normal times when the hot water apparatus WH is not executing a hot water supply operation, the motor drive shaft 8 and the valve body 7 of the valve device A are controlled to be at the boundary angle α3 (S1). Next, when a hot water supply terminal (not shown) connected by piping to the hot water outlet 44 is opened and hot water starts to flow, and the hot water flow rate of the heat exchanger 11 becomes equal to or greater than a predetermined minimum operating flow rate (MOQ-ON), which is detected based on the detection signal from the flow rate sensor Sa, the burner part 2 is turned on (S2: YES, S3). As a result, hot water heating using the heat exchanger 11 begins, and hot water output from the hot water outlet 44 is initiated.

During such a hot water supply operation, the controller 5 executes an operation of normal control to control the flow rate Qa of heated hot water and the flow rate Qb of bypass hot water in the valve device A so that the hot water outlet temperature from the hot water outlet 44 becomes the desired target hot water outlet temperature Ta1 (target hot water supply temperature) (S4). The control to set the hot water outlet temperature to the desired target hot water outlet temperature Ta1 is basically performed in the temperature adjustment range mode. However, in some cases, it may be difficult to generate hot water at the target hot water outlet temperature Ta1 even with the burner part 2 set to the maximum combustion power or close to it, for reasons such as the target hot water outlet temperature Ta1 being considerably higher than the water inlet temperature. In such cases, the valve device A transitions to the flow rate adjustment range mode and responds by reducing the overall flow rate.

Next, during the aforementioned hot water supply operation, when at least one of the predetermined first and second conditions is satisfied, a control mode change restriction of the valve device A is implemented (S5: YES, S6).

Here, the control mode change restriction refers to the prohibition of changing from the temperature adjustment range mode to the flow rate adjustment range mode of the valve device A, and also includes the prohibition of changing from a boundary between the temperature adjustment range mode and the flow rate adjustment range mode to the flow rate adjustment range mode.

The first condition is that the heat exchanger outlet side temperature Tout detected by the temperature sensor Sc is higher than a predetermined reference temperature Ta.

The reference temperature Ta is, for example, the target hot water outlet temperature Ta1, an outlet side target temperature Ta2 of the heat exchanger 11, or a temperature Ta3 determined based on these temperatures Ta1 and Ta2.

The outlet side target temperature Ta2 of the heat exchanger 11 is the heat exchanger outlet side temperature considered suitable for making the actual hot water outlet temperature match the target hot water outlet temperature Ta1, and is decided in the controller 5 based on data of the target hot water outlet temperature Ta1 and the water inlet temperature.

The temperature Ta3 corresponds to, for example, a temperature obtained by correcting the target hot water outlet temperature Ta1 or the outlet side target temperature Ta2 of the heat exchanger 11. As indicated by the virtual line in FIG. 7, in a case where the flow rate Qb of the bypass hot water is not zero at the boundary angle α3 and the vicinity, a small amount of bypass hot water is mixed with the heated hot water flowing out from the heat exchanger 11, resulting in a decrease in temperature. The outlet side target temperature Ta2 of the heat exchanger 11 and the temperature Ta3 are temperatures that take such circumstances into consideration.

The second condition is that a cumulative flow rate ΣQa of heated hot water in the hot water outlet passage 41 from the most recent start of hot water flow to the present time point has not reached a predetermined reference cumulative flow rate ΣQth.

Here, the cumulative flow rate ΣQa is calculated as an accumulated value of the flow rate (flow rate per unit time) detected by the flow rate sensor Sa. The reference cumulative flow rate ΣQth is, for example, the volume of the heat exchanger 11 or a value obtained by adding a margin to this volume, and is preferably set to a value equal to or greater than the volume of the heat exchanger 11.

The operation control described above provides the following effects.

That is, in a situation where the hot water apparatus WH is switched from operation on to operation off, and a post-boiling phenomenon occurs in which the hot water in the heat exchanger 11 is heated to a high temperature by residual heat, the burner part 2 may be driven on in step S3 described above as a restart of the hot water apparatus WH. In this case, if the valve device A is set to the flow rate adjustment range mode at a stage where the entire volume of high-temperature hot water in the heat exchanger 11 has not flowed out, it becomes impossible to control and increase the flow rate Qb of bypass hot water to lower the hot water outlet temperature, and there is a risk that high-temperature hot water caused by the post-boiling phenomenon in the heat exchanger 11 may be output to the exterior from the hot water outlet 44.

In contrast thereto, according to this embodiment, when there is a possibility of post-boiling (the first condition is satisfied), or when the entire volume or nearly the entire volume of hot water in the heat exchanger 11 has not yet finished flowing out to the hot water outlet passage 41 (the second condition is also satisfied), the valve device A is not changed to the flow rate adjustment range mode but is maintained in the temperature adjustment range mode. Therefore, it is possible to appropriately adjust the temperature of high-temperature hot water caused by the post-boiling phenomenon, and effectively prevent output of high-temperature hot water resulting from the post-boiling phenomenon. If either the first condition or the second condition is satisfied, the control mode change restriction of the valve device A is implemented, which more thoroughly prevents output of high-temperature hot water.

When both the first and second conditions mentioned above are no longer satisfied, the control mode change restriction of the valve device A is released, and the valve device A returns to the normal control state (S7: YES, S8). Subsequently, if the water inlet flow rate decreases below the minimum operating flow rate (MOQ-OFF), the burner part 2 is driven off (S9: YES, S10).

Although omitted in the flowchart of FIG. 8, when an abnormally high temperature exceeding a predetermined additional reference temperature (higher than the aforementioned reference temperature Ta) is detected by at least one of the temperature sensors Sc and Sd, measures are further taken to prevent or suppress output of abnormally high-temperature hot water from the hot water outlet 44 after driving off the burner part 2. These measures include, for example, control to set the rotation angle of the motor drive shaft 8 and the valve body 7 to the first angle α1 when the valve device A is in the temperature adjustment range mode, while setting the rotation angle of the motor drive shaft 8 and the valve body 7 to the second angle α2 when the valve device A is in the flow rate adjustment range mode. When the valve device A is at the boundary (boundary angle α3) between the temperature adjustment range mode and the flow rate adjustment range mode, control is performed to set the rotation angle of the motor drive shaft 8 and the valve body 7 to the angle among the first angle α1 and the second angle α2 that has the smaller angular difference from the boundary angle α3.

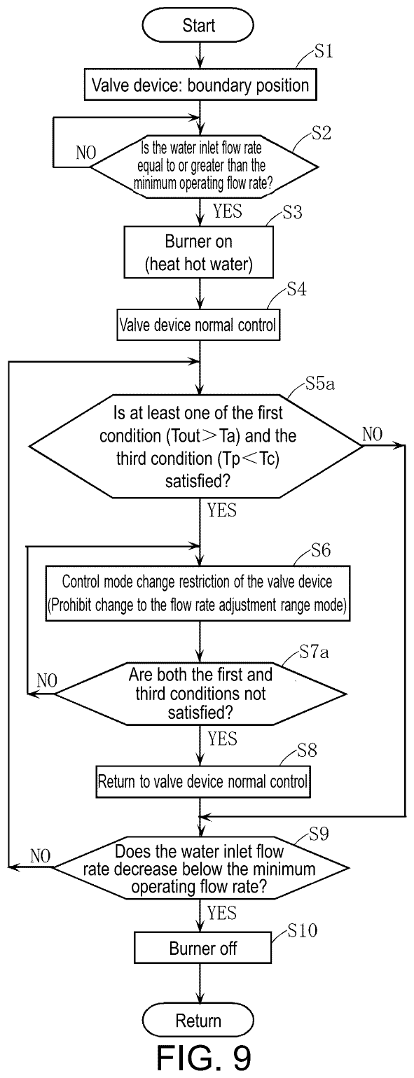

In the hot water apparatus WH of this embodiment, the operation control described in FIG. 9 to FIG. 11 can be executed in place of or in addition to the aforementioned operation control shown in FIG. 8. It should be noted that steps identical or similar to the steps of the operation control shown in FIG. 8 are given the same reference numerals, and duplicate description is omitted.

The operation control shown in FIG. 9 differs from the operation control shown in FIG. 8 in steps S5a and S7a. In step S5a, whether a third condition is satisfied is determined in addition to the aforementioned first condition.

Here, the third condition is that the elapsed time Tp from the most recent start of hot water flow to the present time point has not reached a predetermined reference time Tc. The reference time Tc is preferably the time required for the entire volume of hot water in the heat exchanger 11 to finish flowing out to the hot water outlet passage 41, or this time plus some margin.

In the operation control shown in FIG. 9, when at least one of the first and third conditions is satisfied, control mode change restriction of the valve device A is implemented. Subsequently, when both conditions are not satisfied, the valve device A returns to normal control where the control mode change restriction is released (S5a: YES, S6, S7a: YES, S8).

According to this operation control, in a situation where the post-boiling phenomenon of hot water in the heat exchanger 11 is occurring, the valve device A is appropriately prohibited from being set to the flow rate adjustment range mode at a stage where the entire volume of high-temperature hot water in the heat exchanger 11 has not finished flowing out. Therefore, as in the case shown in FIG. 8, it is possible to effectively prevent output of high-temperature hot water due to the post-boiling phenomenon.

The third condition can be determined to be satisfied or not satisfied by monitoring time, making it possible to simplify this determination.

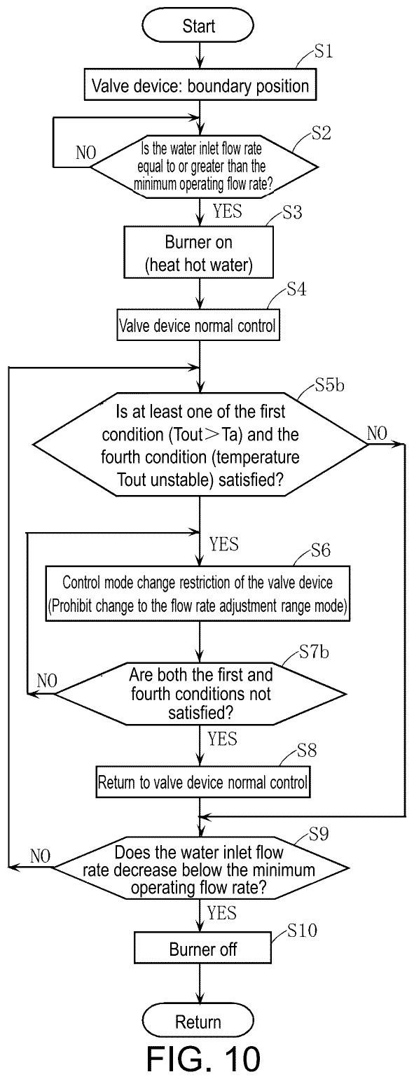

The operation control shown in FIG. 10 differs from the operation control shown in FIG. 8 in steps S5b and S7b. In step S5b, whether a fourth condition is satisfied is determined in addition to the aforementioned first condition.

Here, the fourth condition is that the heat exchanger outlet side temperature Tout is in a predetermined unstable state. The predetermined unstable state refers to, for example, a state where the up and down fluctuation range and/or the up and down fluctuation frequency of the heat exchanger outlet side temperature Tout during the period from the present time point to a predetermined time is not within a predetermined range.

In the operation control shown in FIG. 10, when at least one of the first and fourth conditions is satisfied, control mode change restriction of the valve device A is implemented, and when both the conditions become unsatisfied thereafter, the valve device A returns to normal control where the control mode change restriction is released (S5b: YES, S6, S7b: YES, S8).

As the operation of the hot water apparatus WH is repeatedly turned on and off in a short period of time, high-temperature hot water is generated in the heat exchanger 11 due to the post-boiling phenomenon, and when this hot water flows out to the hot water outlet passage 41, the heat exchanger outlet side temperature Tout tends to become unstable. According to the operation control shown in FIG. 10, in such cases, control mode change restriction of the valve device A is implemented, so that output of high-temperature hot water due to the post-boiling phenomenon can be appropriately prevented, similar to the cases in FIG. 8 and FIG. 9 described earlier. Additionally, there is an advantage that output of high-temperature hot water can be appropriately prevented even in cases where there is a risk of outputting high-temperature hot water for reasons other than the post-boiling phenomenon.

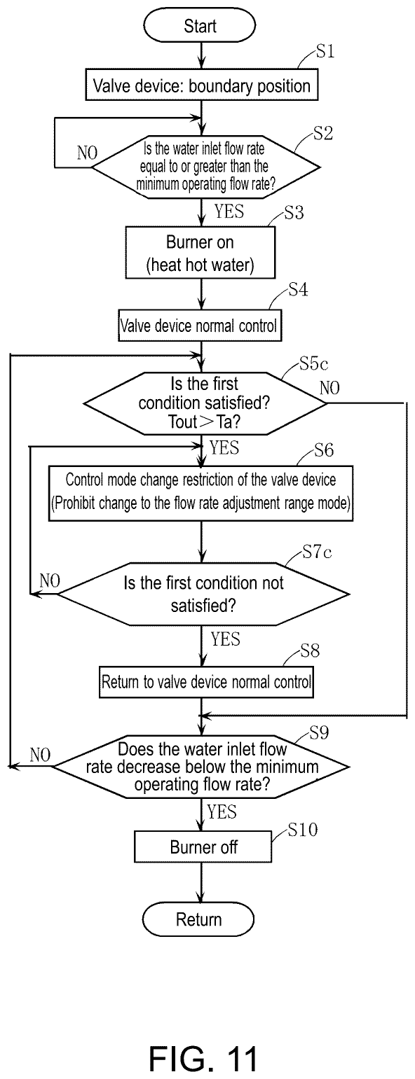

The operation control shown in FIG. 11 does not determine the aforementioned second to fourth conditions, but only determines whether the first condition is satisfied, and when the first condition is satisfied, control mode change restriction of the valve device A is implemented (S5c: YES, S6).

In this operation control, if the heat exchanger outlet side temperature Tout is higher than the reference temperature Ta, control mode change restriction of the valve device A is implemented. Therefore, control mode change restriction of the valve device A can be reliably implemented not only in the case of a post-boiling phenomenon but also in cases where there is a risk of outputting high-temperature hot water due to other phenomena. When the first condition becomes unsatisfied in the state where control mode change restriction is implemented, the valve device A returns to normal control (S7c: YES, S8).

The disclosure is not limited to the content of the embodiment described above. The specific configuration of each part of the hot water apparatus related to the disclosure can be freely designed in various ways within the intended scope of the disclosure.

Regarding the above-described embodiment, the above-described embodiment uses the valve device A as a distribution valve installed at the cross connection point between the water inlet passage 40 and the bypass passage 42, but the disclosure is not limited thereto. For example, the valve device A can also be installed at the cross connection point (corresponding to the intermediate point Pa) between the hot water outlet passage 41 and the bypass passage 42, and can be used as a mixing valve for mixing heated hot water and bypass hot water.

As the valve device, it is possible to use other configurations, such as the valve device described in Patent Literature 2, instead of the valve device A in the above-described embodiment. Moreover, the valve device is not limited to the rotary type. For example, as described in Patent Literature 3, there are valve devices that can control flow rate by sliding a spool valve in response to the rotation angle of the drive shaft of the motor, and such valve devices can also be used.

In any case, the specific configuration of the valve device used in the disclosure is not limited, and the essential point is that the valve device has a configuration capable of sequentially executing flow rate control in a predetermined temperature adjustment range mode and flow rate control in a flow rate adjustment range mode.

The above-described hot water apparatus includes a burner part with a premixing system, but the burner part does not necessarily have a premixing system. Additionally, instead of a gas burner system, an oil burner system can also be used.

The hot water apparatus referred to in the disclosure is not limited to a hot water supply apparatus, but is a concept that also includes apparatuses that generate hot water for purposes other than general hot water supply or bath water supply, such as hot water apparatuses for floor heating.

What is claimed is:

1. A hot water apparatus, comprising:
a water inlet passage and a hot water outlet passage respectively connected to an inlet side and an outlet side of a heat exchanger for hot water heating;
a bypass passage bypassing the heat exchanger to connect the water inlet passage and the hot water outlet passage to each other, and mixing hot water from the water inlet passage, as bypass hot water, with heated hot water flowing through the hot water outlet passage; and
a valve device capable of changing a flow rate of the heated hot water flowing through the hot water outlet passage and a flow rate of the bypass hot water flowing through the bypass passage,
the hot water apparatus being capable of sequentially executing flow rate control in a temperature adjustment range mode and a flow rate adjustment range mode, as control modes of the valve device, in a process where a rotation angle of a motor drive shaft for a valve operation changes between a predetermined first angle and a second angle, wherein the temperature adjustment range mode is capable of changing a mixing flow rate ratio of the heated hot water and the bypass hot water to adjust a hot water outlet temperature to exterior, and the flow rate adjustment range mode is capable of adjusting a total flow rate of hot water flowing through the valve device so that the flow rate of the heated hot water is changed while maintaining the flow rate of the bypass hot water at or below a predetermined minimum flow rate,
wherein a first condition is defined as that an outlet side temperature of the heat exchanger is higher than a predetermined reference temperature, and
the valve device is configured so that, in response to the first condition being satisfied, a control mode change restriction is implemented to prohibit change from the temperature adjustment range mode and from a boundary between the temperature adjustment range mode and the flow rate adjustment range mode to the flow rate adjustment range mode.

2. The hot water apparatus according to claim 1, wherein the predetermined reference temperature is a target hot water outlet temperature, an outlet side target temperature of the heat exchanger, or a temperature determined based on the target hot water outlet temperature and the outlet side target temperature.

3. The hot water apparatus according to claim 1, wherein a second condition is defined as that a cumulative flow rate of the heated hot water in the hot water outlet passage from a most recent start of hot water flow to a present time point has not reached a predetermined reference cumulative flow rate,
in response to the second condition being satisfied instead of or in addition to the first condition, the control mode change restriction is implemented, and
the control mode change restriction is configured to be released in response to both the first condition and the second condition being not satisfied.

4. The hot water apparatus according to claim 1, wherein a third condition is defined as that an elapsed time from a most recent start of hot water flow to a present time point has not reached a predetermined reference time,
in response to the third condition being satisfied instead of or in addition to the first condition, the control mode change restriction is implemented, and
the control mode change restriction is configured to be released in response to both the first condition and the third condition being not satisfied.

5. The hot water apparatus according to claim 1, wherein a fourth condition is defined as that the outlet side temperature of the heat exchanger is in a predetermined unstable state,
in response to the fourth condition being satisfied instead of or in addition to the first condition, the control mode change restriction is implemented, and
the control mode change restriction is configured to be released in response to both the first condition and the fourth condition being not satisfied.
